(19) United States
(12) Patent Application Publication
(10) Pub. No.: US 2004/0130967 A1
(43) Pub. Date: Jul. 8, 2004

(54) Mixing element

(76) Inventors: Christian Wolf, Krailling (DE); Paul Ludwig Geiss, Zdar-Oberstein (DE)

Correspondence Address: DAVID TOREN, ESQ., SIDLEY, AUSTIN, BROWN & WOOD, LLP, 787 SEVENTH AVENUE, NEW YORK, NY, 10019-6018, US

(21) Appl. No.: 10/686,856

(22) Filed: Oct. 15, 2003

(30) Foreign Application Priority Data
Oct. 17, 2002 (DE) 102 48 541.0

(51) Int. Cl. B01F 5/06

(52) U.S. Cl. 366/340

(57) ABSTRACT

An element (21) for mixing a mass formed of a plurality of components has an input opening (28) for supplying the at least two components into the mixing element (21), an output opening (31) for discharging the mixed mass, and at least one flow channel provided between the input opening (28) and the discharge output (31), with the flow channel being oriented perpendicular to the direction of the input opening (28) or of the output opening (31).

### BACKGROUND OF THE INVENTION

1. Field of Invention

The present invention relates to a mixing element for mixing of a mass formed of a plurality of components, in particular an adhesive formed of at least two components, having at least one charging opening for adding the at least two components into the mixing element, at least one output opening for discharging the mixed mass, and at least one flow channel between the at least one charging opening and the at least one output opening.

2. Description of the Prior Art

Multiple component masses are used in different areas of daily life. In the construction and building industry, multiple component masses are used for chemical anchoring of pegs, adhesive fasteners, or seals. Because the individual components are reacted with each other for obtaining specific material properties, the components must be kept in separate containers up to the time of their utilization and can be mixed with each other only a short time before their utilization.

Known multiple component mixers for processing of paste-like and liquid multiple materials usually have a tube with an input and an output and a round cross-section and in which spiral, twisted or convoluted configured inserts are positioned for thorough mixing of the components. With the inserts, the mass stream of the components to be mixed are separated several times and then are reunited, and the thorough mixing of the components is achieved by rotating current, turbulence, and reversal of direction. Accordingly, the direction of flow of the materials to be mixed or components runs essentially parallel to the longitudinal axis of the tube body.

In practice, this type of multiple component mixers are, for example, known as static mixer tubes. The static mixer tubes normally have a more or less rod-shaped configuration, with the required number of repeating mixer insert arrangements in the static mixer tube defining the tube length.

The drawback in the prior art solution consists in that the prior art static mixer tube, because of it unavoidable length, requires a relevant space for storage, shipping and handling at the time of utilization. When utilizing an extrusion machine for paste-like, multiple component masses which have to be mixed, the workspace is frequently adequate for setting up a static mixer tube on the extrusion machine. It is a different matter in the case of an extrusion machine, so-called dispensers, for a multiple component adhesive. The prior art mixer tubes are difficult to handle in such an application, because these are difficult to position manually because of their lengths, which can be an obstacle for exact application of the mixed mass.

A further, essential drawback in the prior art static mixer tubes is the residual quantity that remains in the mixing path at the time of an interruption of work and is partially mixed. Because the components start to react already when partially mixed together, the mixing element must be removed before the work resumes, and the remaining material, which generally consists of costly materials, must be removed together with the static mixer. However, multiple component adhesives, in particular, are expensive and frequently, as a result of the length of the mixing path required for proper thorough mixing, remain in the static mixer than are effectively applied onto the application surface.

An object of the present invention is to provide a mixing element that is compact, can manageably be handled, and with only a minimal residual amount of partially mixed mass which needs to be removed. In addition, the mixing element should be simple and inexpensive to manufacture.

### SUMMARY OF THE INVENTION

These and other objects of the present invention, which will become apparent hereinafter, are achieved by providing an element for mixing a mass formed of a plurality of components, in particular an adhesive formed of at least two components, and having at least one input opening for charging the at least two components into the mixing element and at least one output opening for discharging the mixed mass. Between the at least one input opening and the at least one output opening at least one flow channel is provided. The direction of flow of the mixed components in the flow channel runs essentially orbitally to the longitudinal axis of the body of the mixing element.

Consequently, the orientation of the flow channel runs perpendicular to the direction of the at least one input opening or to the at least one output opening. Because the required mixing path for completely thorough mixing of the added components is not arranged in the direction of the input and output openings, the mixing element according to the invention has an essentially lower structural height than a prior art static mixer tube. The components are compressed in the input opening of the mixing element and, as a result of the flow pressure, are guided through the flow channel. By the deflection of the mass jet perpendicular to the input opening and a new deflection at the output opening, the added components are mixed, and the mixed mass is discharged through the output opening. In addition, the flow channel, instead of vertical arrangement, can be inclined with respect to the direction of the input or the output opening, so that the pressure conditions along the flow channel, which act upon the components to be mixed, change, and the thorough mixing of these components is further improved.

In one embodiment of the mixing element according to the invention, several input openings are arranged thereon, into which the individual components of the mass to be mixed can be fed to the mixing element separately. When this is done, the input openings are arranged along the flow channel so that individual components are initially added to other components, if these have already gone through a certain mixing. With this embodiment of the mixing element, specific masses having special properties can be manufactured and which, depending on their application, contain a large or a limited number of components.

With a large surface mixing element, for example, a plurality of output openings are provided on the mixing element, through which the mixed mass is discharged in and/or onto a substrate. Accordingly, fast application of the mixed mass is insured which is an advantage, especially in the case of large surface application and components that react quickly with each other. In this way, in the case of larger mixing elements, hardening of the mixed mass can be prevented in the mixing element, because the mixed mass discharges too slowly from the mixing element through the output opening of the mixing element. If required, the mixing element can have a plurality of input openings and a plurality of output openings.

Preferably, the flow channel inside a mixing plane has an essentially circular flow direction. In this embodiment, the components to be mixed, when flowing through the flow channel, are additionally exposed to a centrifugal force, which enhances the thorough mixing of the components. An essentially circular direction of flow, for example, is defined also by a flow channel having a serpentine course running essentially perpendicular to the direction of the input or output opening. If the mixing element, for example, has a cylindrical configuration with rectangular base surfaces, there can be deviations from the circular-orbital direction of flow in the flow channel.

Preferably, a plurality of deflection elements are arranged in the mixing plane, enhancing the mixing of the components, wherein the deflection elements are configured to be optionally pivoted. These deflection elements are used essentially as flow separators which, for example, by means of a rotation of the flow, generation of turbulence, or reversal of direction, provide for thorough mixing of the components to be mixed and insure uniform mixing of the mixed mass in the mixing element. The deflection elements have a cross-section, for example, of a segmented circular ring or are sickle-shaped. Likewise, a configuration of the deflection elements as resistance elements, for example, can be obtained by using a disc-type configuration. The deflection elements preferably have openings, through-passages, or recesses so that the flow is locally accelerated and then decelerated, which has an advantageous effect on the thorough mixing of the components with a minimal structural height of the mixing element according to the invention.

Advantageously, the flow channel is guided over a plurality of mixing planes, preferably, serially connected with each other. If the dimension of the mixing element is restricted in a direction perpendicular to the input opening or perpendicular to the output opening as a consequence of the external conditions or if a maximal dimension is desired, for example, due to manufacturing considerations, the mixing path available in the mixing element for complete and thorough mixing of the components may not be adequate. In order to provide sufficiently long mixing path several mixing planes can be provided in one mixing element. These mixing planes preferably are serially connected with each other so that the components to be mixed pass through a first mixing plane and then the flow is directed into a second and, if necessary, into further mixing plane, until inner mixing of the components to be mixed is insured.

Instead of a mixing element with a plurality of mixing planes, a plurality of mixing elements can be arranged one over the another. In order to do this, preferably, on a first surface of the mixing element and on a second surface opposing said first surface of the mixing element, mating engagement elements are arranged. In this way as many mixing elements can be “stacked” on top of each other as needed to obtain the required length of the mixing path of the flow channel. By a serial connection of the mixing elements, the individual mixing planes can be connected.

If large quantities of the mass produced in the mixing element are required within specific periods of time, the mixing planes of a mixing element can, for example, instead of utilizing a plurality of mixing element, be connected in parallel to each other. A parallel assembly of a plurality of stacked mixing elements, with each having only one mixing plane, is also conceivable.

Preferably, the mixing element comprises a cylindrical or a semi-cylindrical body. Along with a circular cylindrical body, the term cylindrical body can also be understood to be a body, whose both base surfaces are connected parallel, evenly, congruently and using a sleeve surface with each other. In particular, in the case of a flow channel, which defined a circular direction of flow within a mixing plane, the configuration of the mixing element as a circular cylindrical body is advantageous because in this configuration, the relationship between the quantity of the material to be used in production in the mixing element and the effective volume available in the flow channel can be optimized. Along with the circular cylindrical execution, the mixing element can have, for example, a parallelepiped configuration.

The mixing element can in one embodiment, for example, be formed in two parts. In order to do this, for example, the base surface with the input opening is configured to be detachable from the output opening and the wall running axially to the output opening and the base surface of the mixing element having any eventually available deflection elements. Depending on the application, in one such embodiment, differently configured base plates with different quantity of input openings can be provided on the corresponding mating part of the mixing element.

Preferably, the input opening and the output opening are arranged on one axis. On one hand, the manufacture of the mixing element is simplified and, on the other hand, the mixing element can be configured symmetrically mirrored relative to said axis. The input opening can, for example, be provided with a flange that can be brought as engagement means into a recess which forms mating engagement means at the output opening. Consequently, several mixing elements can be easily serially assembled, stacked upon one another in order to extend the mixing path.

Preferably, the height of the flow channel can be reduced in order to reduce the internal volume of the mixing element. For example, the inner and outer walls laterally limiting the flow channel can be folded or elastically configured so that they do not impair the reduction of the inside volume of the mixing element. Furthermore, at least one of the base surfaces is arranged so as to be detachable from the inner and/or outer wall. Accordingly when reducing the inner volume, at least one of the walls is retained in the original section.

Insofar as the mixing element has deflection elements, these are preferably pivotably arranged on the base surfaces of the mixing element, for example, by narrowing of the material or with a hinge. The elements of the mixing element extending in an axial direction of the input or output opening can, in an alternative embodiment, be so configured that they can be folded together axially. As already discussed in the introduction, the components react already in the partially mixed mass in the case of an interruption in the work process, whereby the mixing element must be replaced prior to starting a new mixing process. In this embodiment of the mixing element according to the invention, the largest part of the mass present in the mixing element can be reused due to the reduction in the inside volume.

Preferably, the height of the flow channel can be reduced by a rotary movement of at least one of the base surfaces of a cylindrical or half-cylindrical body. For example, in a first step, only a part of the totality of required quantity of the mixed mass is produced by the mixing element. In a second step, the axial height of the mixing element is reduced by a rotary movement and/or a linear movement. In this process, the quantity of components to be mixed in the mixing element is forced along the flow channel and is discharged for the most part as completely thoroughly mixed mass out of the output opening. This quantity corresponds in part to the entirety of the required quantity of the mixed mass that is required on the application site in addition to the mass produced in the first step. The quantity remaining in the mixing element and that needs to be removed of the generally expensive material is reduced to a minimum, which has positive implications on the economics of the overall application for the user.

Preferably, the mixing element is arranged on a mounting plate that can be attached with the mixed mass to a constructional component. This arrangement is particularly advantageous for production of an adhesive connection between the mounting plate and a constructional component. The mixing element is advantageously configured for the required quantity of the mass to be mixed for insuring the connection and has, for example, a fill level indicator that can be read by the user. When adding the components to be mixed, the user will be able to tell from this, if the required quantity of material has been filled into the mixing element. If the mixing element is foldable, after removal of the extrusion machine or the dispenser, the mixing element can be pushed out and the quantity of material filled into the mixing element for establishing the desired connection can be almost completely used up. If the mixing element comprises a fill level indicator, it is preferably so configured, that the quantity of completely mixed mass is available when pressing or turning out of the mixing element, and same is taken into account in the fill level indication. Using this embodiment, the economics, in particular in the case of a plurality of fastening plates in one area, can be substantially increased in contrast with the prior art.

Advantageously, the mixing element is manufactured of plastic, optionally in an injection molding process. Further, the mixing element can be manufactured of metal, for example, as a sheet metal punch/ben part.

### BRIEF DESCRIPTION OF THE DRAWINGS

The advantageous embodiments and combinations of features of the present invention will become more apparent from the following detailed description of the preferred embodiments when read with reference to the accompanying drawings in which identical elements are designated with the same reference numerals.

The drawings show:

FIG. 1 a perspective partial view of a first exemplary embodiment of the mixing element according to the invention;

FIG. 2 is a perspective view of a second exemplary embodiment of the mixing element according to the invention;

FIG. 3 a perspective cross-sectional view along the line III-III in FIG. 2;

FIG. 4 a perspective partial view of a third exemplary embodiment of the mixing element according to the invention;

FIG. 5 a perspective partial view of a fourth exemplary embodiment of the mixing element according to the invention;

FIG. 6a a diagrammatic perspective view of a foldable mixing element in the normal condition;

FIG. 6b a diagrammatic perspective view of the mixing element shown in FIG. 6a in a folded condition.

FIG. 7 a perspective view of a fastening assembly with an associated mixing element according to the invention;

FIG. 8 a bottom view of the fastening assembly shown in FIG. 7.

### DETAILED DESCRIPTION OF THE PREFERRED EMBODIMENTS

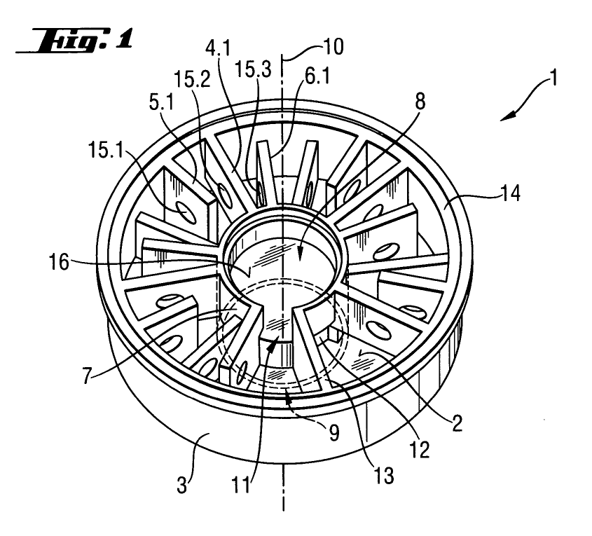

For clarity sake, in FIGS. 1 to 6, the top surface is not shown.

A perspective partial section of a first exemplary embodiment of the mixing element according to the invention is shown in FIG. 1. The mixing element 1 is formed of two parts, with only the bottom part of the mixing element being shown. The bottom part has a bottom base surface 2, an outer wall 3, and an inner wall 7. A circular flow channel runs between the outer wall 3 and the inner wall 7. An input opening 8 and an output opening 9 lie on a common axis 10 and are split by of a bottom partition 16. In the inside wall 7, an access opening 11 is provided that branches from the input opening 8 perpendicular to the axis 10 and creates the connection between the input opening 8 and the flow channel. The mass mixed in the mixing element 1 exits the flow channel through the output opening 12 provided in the inner wall 7 and through the discharge opening 9. The access opening 11 is separated from the discharge opening 12 by a partition 13. At the outer wall 3, a receptacle is formed for receiving an upper base plate (not shown).

In the annular space between the outer wall 3 and the inner wall 7, a number of deflection elements 4.1., 5.1 and 6.1 are provided for creating a plurality of sections. The deflection elements insure thorough mixing of the components fed via the input opening of the mixing element 1. Accordingly, the deflection elements 4.1, 5.1 and 6.1 are arranged essentially alternatingly along the flow channel and radially with respect to the axis 10. Each of the deflection elements 4.1, 5.1 and 6.1 is provided with an opening, e.g. the openings 15.1, 15.2 or 15.3, which as flow separators further enhance the effects of the deflection elements 4.1, 5.1 and 6.1 at the time of flow through of the components to be mixed. By way of example, the deflection element 4.1 can be pushed in a disc-like manner from the inner surface of the outer wall 3 to the outer surface of the inner wall 7. The mass to be mixed and in contact with this deflection element 4.1 can pass in the direction of flow only through the opening 15.2 into the next section of the flow channel. The deflection element 5.1 is similarly configured as a disc-shaped member and adjoins the inside edge of the outer wall 3. However, the deflection element 5.1 is not, however, guided completely up to the outside edge of the inner wall 7. The mass to be mixed and in contact with this deflection element 5.1 can pass in the direction of flow though the opening 15.1 and the available free space into the next section of the flow channel. The deflection element 6.1 is also similarly configured as a disc-shaped member but it adjoins the outer edge of the inner wall 7 and is not completely guided up to the inner edge of the outer wall 3. The mass to be mixed and in contact with this deflection element 6.1 can pass in the direction of flow through the opening 15.3 and the available free space into the next section of the flow channel.

The components to be mixed are fed by an extrusion system or a dispenser through the input opening 8 of the mixing element 1. The components pass through the access opening 11 into the flow channel and passed over in a clockwise rotation as a result of the flow pressure along the flow channel onto the deflection elements 4.1, 5.1 and 6.1. With these flow rotations, reversals of a direction and turbulence are produced so that over the length of the flow channel, the components to be mixed are combined with the mass in a desired mix. At the end of the flow channel, the mixed mass contacts the partition 13 and is discharged through the output opening 12 of the flow channel to the outlet opening 9 of the mixing element 1.

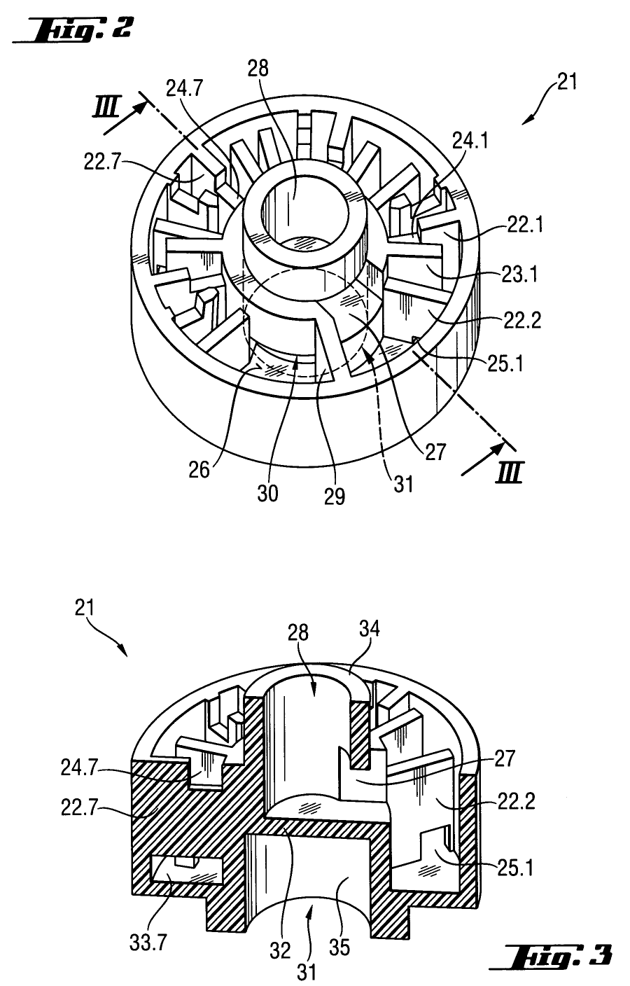

FIG. 2 shows a perspective partial view of a second exemplary embodiment of the mixing element according to the invention. The mixing element 21 represented herein has, in contrast with the mixing element 1 described hereinbefore, deflection elements 22.1, 22.2, 22.7, 23.1, which are provided with recesses 24.1, 24.7 in the area of the upper base surface (not shown), and deflection elements alternating with these deflection elements are provided with recesses 25.1 in the area of the bottom base plate 26.

The components to be mixed are forced via the access opening 27 out of the input opening 28 into the flow channel and pass around the deflection elements 22.1, 22.2, 22.7, 23.1 in a counterclockwise direction. Once the mixed mass contacts the partition, it is forced through the output opening 30 into the discharge opening 31 out out of the mixing element 21.

FIG. 3 shows a perspective cross-sectional view along the plane III-III in FIG. 2. The input opening 28 and the output or discharge opening 31 of the mixing element 21 are separated from each other by the partition 32. As can be seen in this drawing, a further passage 33.7 can be provided in the deflection elements; e.g., deflection element 22.7 alongside the recess 24.7.

A flange 34 is formed around the input opening 28 and it can engage in the recess 35 in the area of the output opening 31. Accordingly, a plurality of mixing elements 21 can be serially connected with each other in order to extend the mixing path of the flow channel.

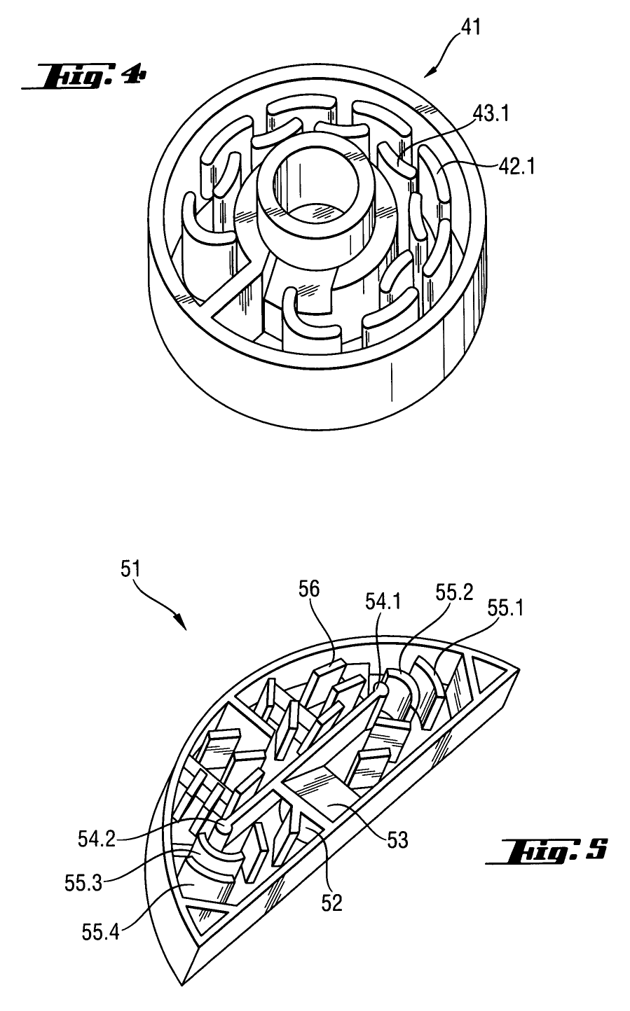

FIG. 4 shows a perspective partial view of a third exemplary embodiment of the mixing element according to the invention. In this embodiment, the deflection elements 42.1, 43.1 are shown as a flat, segment-shaped elements located in the mixing element 41. The deflection elements 42.1, 43.1 can be provided also with recesses, passages or openings in order to insure in-depth thorough mixing.

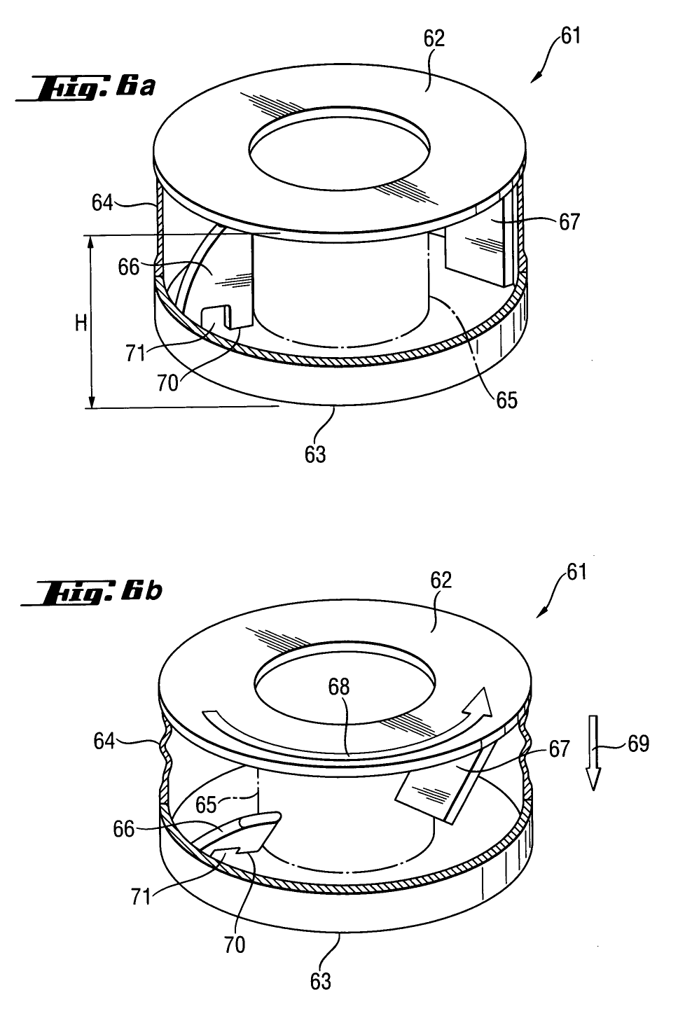

FIG. 5 shows a perspective partial view of a fourth exemplary embodiment of the mixing element according to the invention. The mixing element 51 has, in contrast with the mixing elements 1, 21 and 41 hereinbefore described, a half-cylindrical form. The mode of function of the mixing element 51 is essentially identical to the embodiments described hereinbefore. For separating of the access opening and the output opening 52, an inclined partition 53 is provided.

Because the flow channel in this exemplary embodiment is guided around sharp corners 54.1 and 54.2, the deflection elements 55.1, 55.2, 55.3 and 55.4 in the area of the corners 54.1 and 54.2 are configured differently from the other deflection elements; e.g., deflection element 56.

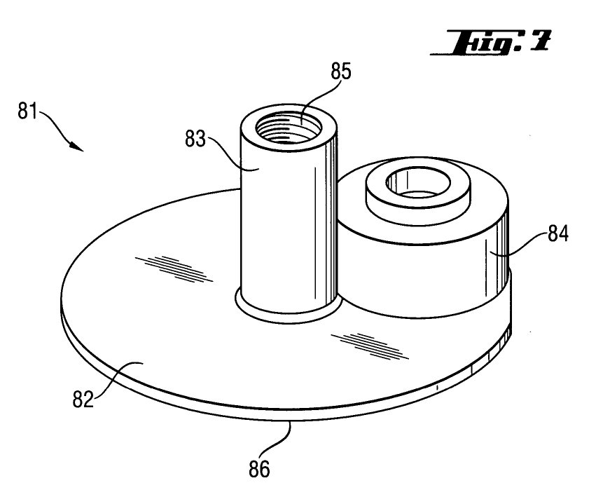

FIG. 6a shows a diagrammatic perspective view of a foldable mixing element under normal condition. Normal condition is understood to mean the condition, in which the components to be mixed are input into the mixing element and are mixed therein.

For the description of the following principle, in the mixing element 61, the outer wall 64 is shown only schematically. The inner wall 65 extends between the top base plate 62 and the bottom base plate 63. The flow channel runs between the outer surface of the inner wall 65 and the inner surface of the outer wall 64. In order to insure a thorough mixing of the components to be mixed, flow separators are arranged in the flow channel; in this case, for example, deflection elements 66 and 67.

The FIG. 6a, mixing element 61 shown is shown in a folded condition in FIG. 6b. Once the desired quantity of the mixed mass is produced in the mixing element 61, input of the components to be mixed is ended. The residual quantity of components to be mixed present in the mixing element 61 are supplied, by being squeezed-out of the mixing element 61, for further utilization of the mixed mass. By the rotary movement of the upper base plate 62, for example in the direction of the arrow 68, the axial height H is reduced to zero. The squeezing can also be enhanced by displacement in the direction of the arrow 69.

For this purpose, the outer wall 64 and the inner wall 65 are formed so that they are foldable, collapsible, for example, in order not to impair the squeezing operation. The deflection elements 66 and 67 are pivotable; e.g., arranged at the top base plate 62 and/or on the bottom base plate 63 or are at least held temporarily at at least one of the base plates 62 and/or 63 in the normal condition of the mixing element 61. The deflection element 66 is released from its mounting on the base plate 62 when a rotary movement is applied and inclines about the joint 70 in the direction of the arrow 68. Because the flow separator 66 is provided with a passage 71 in the connection zone towards the bottom base plate 63, the mixing operation of the components to be mixed is insured. The deflection element 67 is, in contrast thereto, pivotingly fastened to the top base plate 62 so that it swivels upwards upon rotary movement opposite to the direction of the arrow 68. The arranged flow separators, e.g., the deflection elements 66 and 67, are preferably separated from the inner wall 65 and the outer wall 64 or are arranged only in contact therewith, so that the squeezing operation is not impaired by resistances which are difficult to overcome.

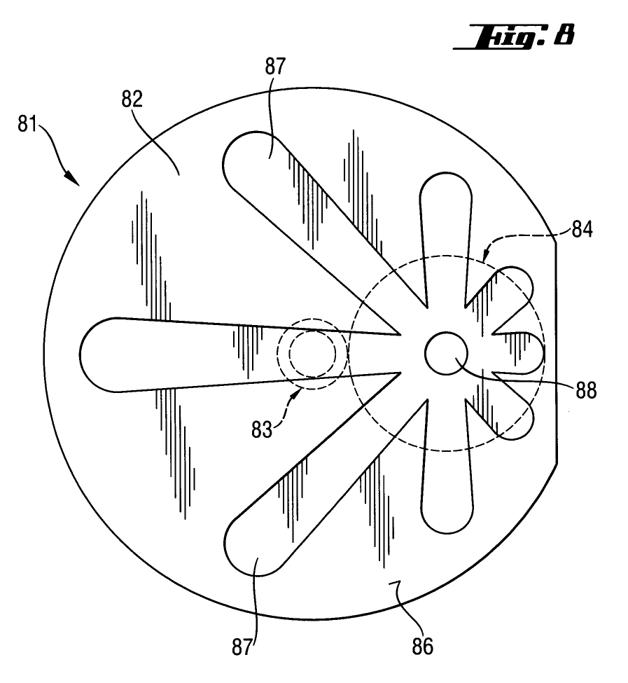

A perspective view of a fastening system with an associated mixing element according to the invention is shown in FIG. 7. FIG. 8 show the fastening system in a view from below. The fastening system 81 is configured for a bonding attachment and includes a the fastening plate 82, a connector element 83, and a mixing element 84. The connector element 83 has, for example, an inner thread 85 in which a screw element can be incorporated. The underside 86 of the fastening plate 82 is, for example, provided with recesses 87, in which the mixed adhesive or a bonding material mixed in the mixing element 84 can spread out, in order to create a flat connection between the fastening plate 82 and a constructional component. The fastening plate 82 has and opening 88 that forms a connection between the upper side of the fastening plate 82 with the recesses on the underside 86 of the fastening plate 82 and engages in the output opening of the mixing element 84. The mixing element 81 is, for example, configured like the hereinbefore described mixing elements 1, 21, 41 or 61.

In summary, there is provided, according to present invention, a mixing element that is compact and manageable. It insures good thorough mixing of the individual components of the mass to be mixed in the mixing element according to the invention, wherein only a minimal residual amount of the partially mixed mass must be disposed of. Accordingly, the costs of using the mixing element are substantially reduced vis-à-vis the prior art solutions. In addition, the mixing element can be easily and inexpensively manufactured. Along with multiple component adhesives, multiple component mortar masses can also be thoroughly mixed in the mixing element according to the invention, which mixed masses can include a number of components.

Though the present invention was shown and described with references to the preferred embodiments, such are merely illustrative of the present invention and are not to be construed as a limitation thereof, and various modifications to the present invention will be apparent to those skilled in the art. It is, therefore, not intended that the present invention be limited to the disclosed embodiments or details thereof, and the present invention includes all of variations and/or alternative embodiments with the spirit and scope of the present invention as defined by the appended claims.

What is claimed is:

1. A mixing element for mixing a mass formed of a plurality of components, comprising at least one input opening (8; 28) for supplying at least two components into the mixing element (1; 21; 41; 51; 61; 84) at least one output opening (9; 31) for discharging the mixed mass; and at least one flow channel provided between the at least on input opening (8; 28) and the at least one discharge opening (9; 31), wherein a direction of flow of the components to be mixed in the flow channel runs essentially orbitally to a longitudinal axis of the mixing element (1; 21; 41; 51; 61; 84).

2. A mixing element according to claim 1, wherein the flow channel defines a substantially circular direction of flow within a mixing plane.

3. A mixing element according to claim 2, wherein a plurality of deflection elements (4.1, 5.1, 6.1, 13; 22.1, 22.2, 22.7, 29; 42.1, 43.1; 55.1, 55.2, 55.3, 55.4, 56; 66, 67) are arranged in the mixing plane for enhancing mixing of the components.

4. A mixing element according to claim 1, wherein the flow channel is guided over a plurality of mixing planes.

5. A mixing element according to claim 4, wherein the mixing planes are connected in series.

6. A mixing element according to claim 1, wherein the mixing element (1; 21; 41; 51; 61; 84) comprises one of a cylindrical and a half-cylindrical body.

7. A mixing element according to claim 1, wherein the input opening (8; 28) and the output opening (9; 31) are arranged on one axis (10).

8. A mixing element according to claim 1, wherein a height (H) of the flow channel is reduced for reducing an inner volume of the mixing element (61).

9. A mixing element according to claim 8, wherein the height (H) of the flow channel is reduced by a rotary movement of at least one of a base surfaces (62, 63) of the at least one of the cylindrical or half-cylindrical body.

10. A mixing element according to claim 1, wherein the mixing element (84) is arranged on a fastening plate (82) that can be fastened to a constructional component.

11. A mixing element according to claim 1, wherein the mixing element (1; 21; 41; 51; 61; 84) is manufactured of a plastic material.

12. A mixing element according to claim 11, wherein the mixing element (1; 21; 4; 51; 61; 84) is manufactured by an injection molding process.

13. A mixing element according to claim 3, wherein the deflection elements (4.1, 5.1, 6.1, 13; 22.1, 22.2, 22.7, 29; 42.1, 43.1; 55.1, 55.2, 55.3, 55.4, 56; 66, 67) are pivotally arranged in the mixing plane.
